(19) United States
(12) Patent Application Publication
(10) Pub. No.: US 2026/0185641 A1
(43) Pub. Date: Jul. 2, 2026

(54) LIQUID-COOLING PLUG CONNECTOR AND CONNECTING APPARATUS HAVING THE SAME

(71) Applicant: JPC CONNECTIVITY INC., New Taipei City (TW)

(72) Inventors: Sheng-Ho YANG, New Taipei City (TW); Chun-Chia CHEN, New Taipei City (TW); Yung-Chih FAN, New Taipei City (TW); Huang-Cheng LU, New Taipei City (TW)

(21) Appl. No.: 19/060,704

(22) Filed: Feb. 23, 2025

(30) Foreign Application Priority Data
Dec. 26, 2024 (TW) 113150986

(51) Int. Cl. F16L 37/32; F16L 37/092

(52) U.S. Cl. CPC F16L 37/32; F16L 37/0927

(57) ABSTRACT

A connecting apparatus includes a liquid-cooling plug connector and a mating connector. The liquid-cooling plug connector includes a plugged body, an unlocking assembly, a backstop assembly, and a locking component. The plugged body has a socket and an operating hole relative to a periphery of the socket. The unlocking assembly is elastically adapted to sheathe outside the plugged body. The backstop assembly is arranged inside as an isolation. The locking component is movably arranged in the operating hole and has a limiting part, a fixing part extended from the limiting part downward to move along an axial direction in the operating hole, an operating surface on the fixing part, and a fixing surface opposite to the operating surface. The unlocking assembly has a stopping surface elastically abutted against the limiting part to cause the locking component to move outward along the axial direction in the operating hole.

### BACKGROUND OF THE DISCLOSURE

### Technical Field

The present disclosure relates to a connector, and especially relates to a liquid-cooling plug connector and a connecting apparatus having the same.

### Description of Related Art

In the existing cooling systems that use the liquid as the circulating heat dissipation, the pipelines used to transport the liquid often need, for example, the quick connectors or the quick connection connectors, to achieve the purposes such as the replacement or the quick connection between the pipelines.

However, the existing quick connectors or quick connection connectors mainly use the ball-shaped stuck-fixing components to roll and be arranged between the mutually connected male ends and female ends, to achieve the purpose of being difficult to disassemble after mating. In this way, the connectors may be prevented from being separated due to the impact of the unexpected external force, resulting in the accidents such as the liquid leakage. However, the ball-shaped stuck-fixing components may still roll freely when stuck, so that the mutually connected male ends and female ends may still detach under a certain external force and may cause the above-mentioned accident.

In view of this, to improve and solve the above-mentioned deficiencies, the inventor has devoted himself to research and combined with the application of the academic theory, and finally provide the present disclosure that is reasonably designed and effectively improves the above-mentioned deficiencies.

### SUMMARY OF THE INVENTION

The main object of the present disclosure is to provide a liquid-cooling plug connector and a connecting apparatus having the same, which use the components to lock the male and female connectors and are designed with more slopes to achieve the locking effect, thereby providing the better tensile strength to prevent the connectors from detaching.

To achieve the object mentioned above, the present disclosure is to provide a liquid-cooling plug connector including a plugged body, an unlocking assembly, a backstop assembly, and at least one locking component. The plugged body has a hollow area in the plugged body. The hollow area extends toward a front end of the plugged body to form a socket. The plugged body has at least one operating hole relative to a periphery of the socket. The unlocking assembly is elastically adapted to sheathe outside the plugged body. The backstop assembly is arranged in the hollow area and is elastically blocked between the socket and the hollow area. The locking component is movably arranged in the operating hole and has a limiting part located outside the operating hole, a fixing part extended from the limiting part downward to move along an axial direction in the operating hole, an operating surface on the fixing part and extending into the socket through the operating hole, and a fixing surface opposite to the operating surface. Moreover, the unlocking assembly has a stopping surface in the unlocking assembly. The stopping surface is elastically abutted against the limiting part to cause the locking component to move outward along the axial direction in the operating hole.

To achieve the object mentioned above, the present disclosure is to provide a connecting apparatus including a mating connector and the liquid-cooling plug connector mentioned above. Moreover, when the mating connector inserts into the socket of the plugged body, the operating surface is pushed to cause the locking component to slide and the fixing surface latches the mating connector. The unlocking assembly has a stopping surface in the unlocking assembly. The stopping surface is elastically abutted against the limiting part to cause the locking component to move outward along the axial direction in the operating hole.

### BRIEF DESCRIPTION OF THE DRAWINGS

FIG. 1 shows a three-dimensional exploded schematic view of the connecting apparatus of the present disclosure.

FIG. 2 shows a partial three-dimensional exploded view of the liquid-cooling plug connector of the present disclosure.

FIG. 3A shows a three-dimensional exploded schematic view of the plugged body of the present disclosure.

FIG. 3B shows a three-dimensional appearance schematic view of the locking component of the present disclosure.

FIG. 4 shows a three-dimensional exploded view of the mating connector of the present disclosure.

FIG. 5 shows a cross-sectional view of a mating state of the connecting apparatus of the present invention.

FIG. 6 shows an operating cross-sectional schematic view (1) of the present disclosure during plugging.

FIG. 7 shows an operating cross-sectional schematic view (2) of the present disclosure during plugging.

FIG. 8 shows an operating cross-sectional schematic view (3) of the present disclosure during plugging.

FIG. 9 shows an operating cross-sectional schematic view of the present disclosure during plugging and unplugging.

### DETAILED DESCRIPTION

To enable the examiner to further understand the characteristics and technical content of the present disclosure, please refer to the following detailed description and drawings of the present disclosure. However, the attached drawings are only for reference and illustration, and are not intended to limit the present disclosure.

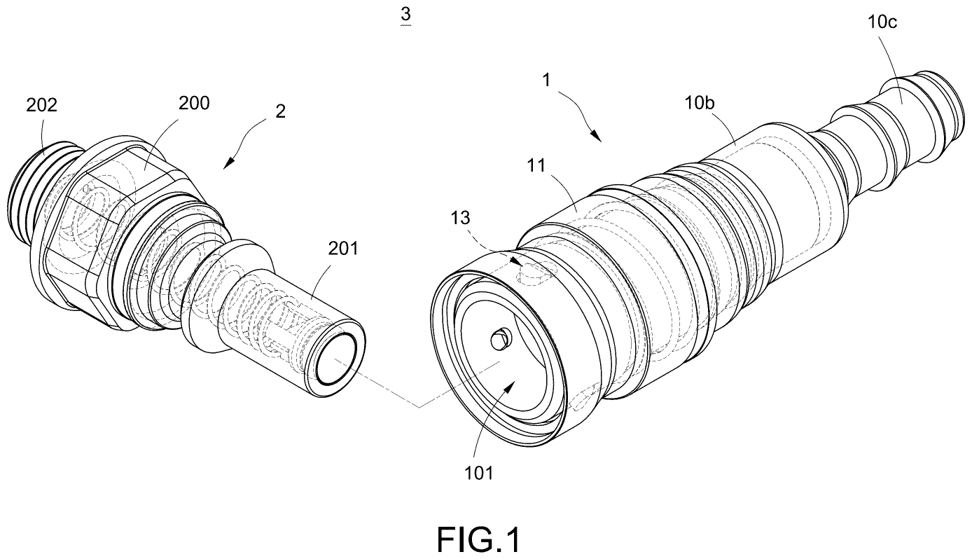

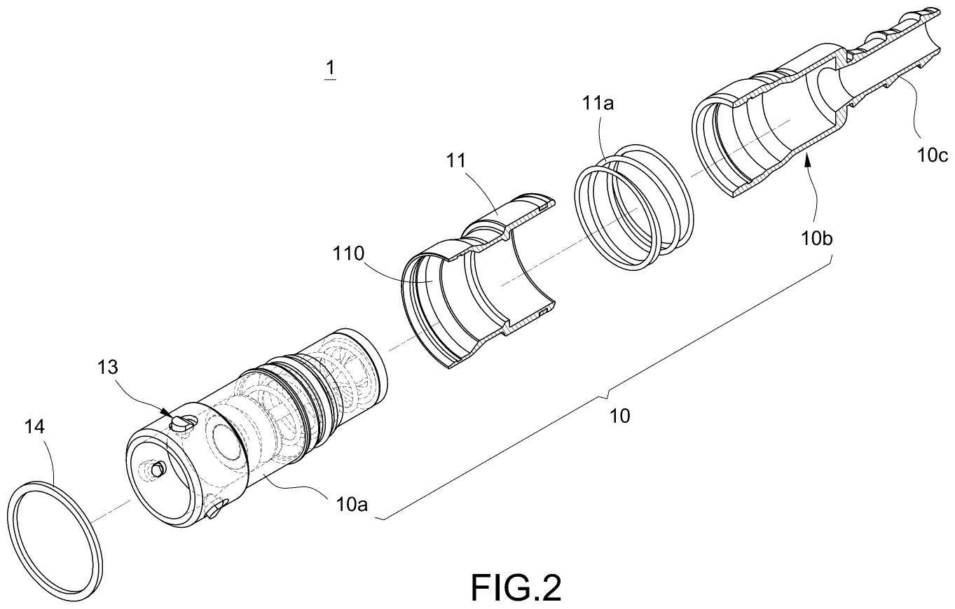

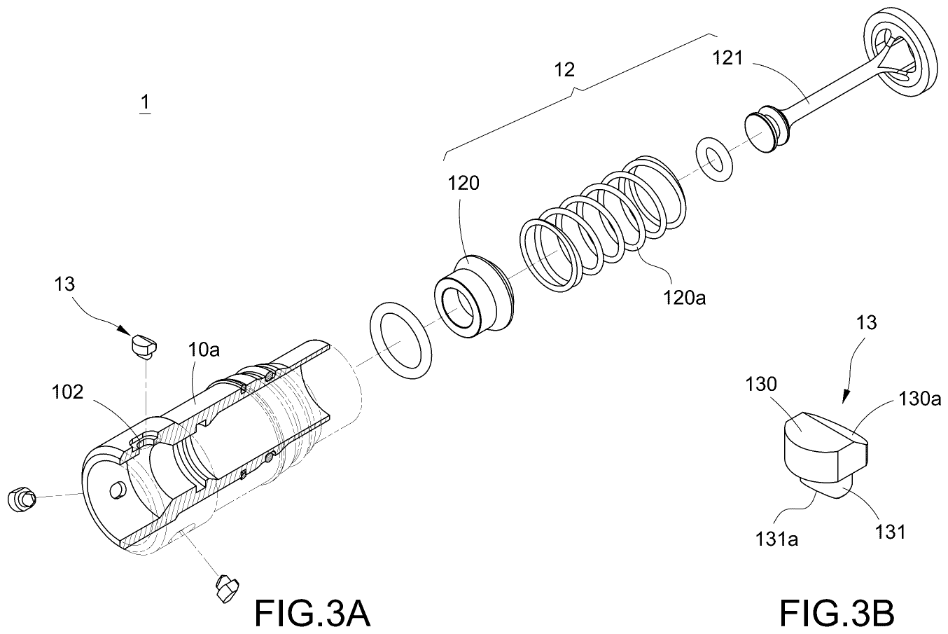

FIG. 1 shows a three-dimensional exploded schematic view of the connecting apparatus 3 of the present disclosure. The present disclosure provides a liquid-cooling plug connector 1 and the connecting apparatus 3 having the same. The connecting apparatus 3 includes the liquid-cooling plug connector 1 and a mating connector 2 which is interconnected with the liquid-cooling plug connector 1. As shown in FIG. 2 and FIG. 3A, the liquid-cooling plug connector 1 includes a plugged body 10, an unlocking assembly 11, a backstop assembly 12, and at least one locking component 13. The descriptions are as follows:

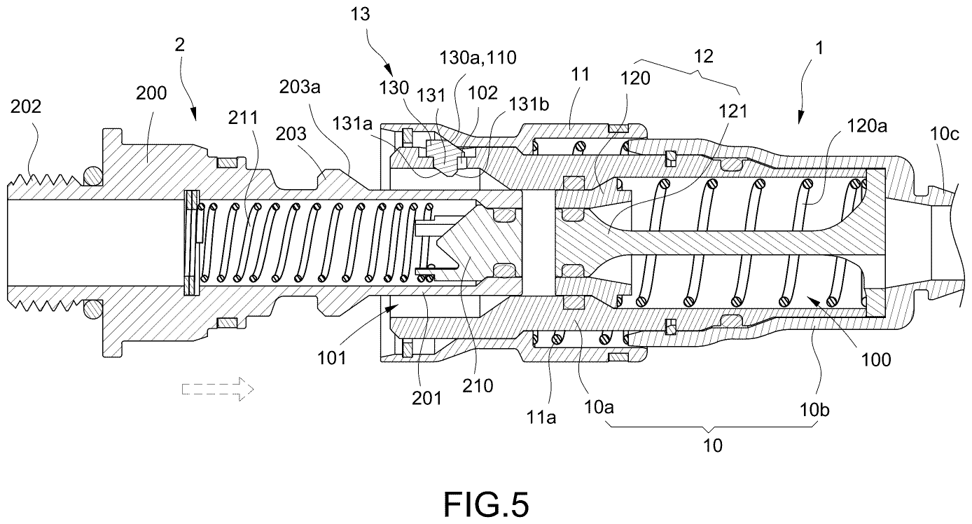

As shown in FIG. 2 and FIG. 3A, the plugged body 10 is used for the unlocking assembly 11 mentioned above to be elastically movably arranged on an outside of the plugged body 10, and for the backstop assembly 12 mentioned above to be arranged inside the plugged body 10. In the embodiment of the present disclosure, referring to FIG. 5 as well, the plugged body 10 may include a body part 10a and a pipe-connecting part 10b. The body part 10a has a hollow area 100 in the body part 10a for the backstop assembly 12 to be arranged inside the hollow area 100. The hollow area 100 extends toward a front end of the body part 10a to connect and form a socket 101. The pipe-connecting part 10b is sleeved on a rear end of the body part 10a and closes the hollow area 100. A pipe-connecting opening 10c is provided at a rear end of the pipe-connecting part 10b, so that the liquid-cooling plug connector 1 may be arranged on a pipeline of a cooling system (not shown) for liquid circulation.

As shown in FIG. 2, the unlocking assembly 11 is movably adapted to sheathe outside the plugged body 10 mentioned above. An elastic component 11a abuts against the plugged body 10 and has an elastic force to move toward the front end of the body part 10a. As shown in FIG. 3A, the backstop assembly 12 includes a piston 120 and a backstop member 121 blocked and arranged on the piston 120. The piston 120 is pushed by an elastic force of an elastic component 120a and is blocked together with the backstop member 121 between the socket 101 and the hollow area 100 mentioned above (as shown in FIG. 5), so that when the liquid of the cooling system enters the plugged body 10 through the pipe-connecting opening 10c, the liquid may be blocked by the backstop assembly 12 and may not overflow from the socket 101.

Please refer to FIG. 3A and FIG. 3B together. The locking component 13 is movably arranged on the body part 10a of the plugged body 10 mentioned above, and located relative to the socket 101. Specifically, the plugged body 10a has at least one operating hole 102 relative to a periphery of the socket 101. The locking component 13 is movably arranged in the operating hole 102. When the number of the locking component 13 is plural, the operating hole 102 is also provided in a corresponding plural number. As shown in FIG. 5, the locking component 13 has a limiting part 130 located outside the operating hole 102, and a fixing part 131 extended from the limiting part 130 downward to move along an axial direction (namely, the plugging direction or the unplugging direction, while the plugging direction is the inward axial direction, and the unplugging direction is the outward axial direction) in the operating hole 102. A size of the fixing part 131 along a radial direction of the operating hole 102 is smaller than a size of the limiting part 130 along the radial direction of the operating hole 102, so that when the locking component 13 is arranged in the operating hole 102, the fixing part 131 may be positioned in the operating hole 102, and the locking component 13 does not fall into the socket 101.

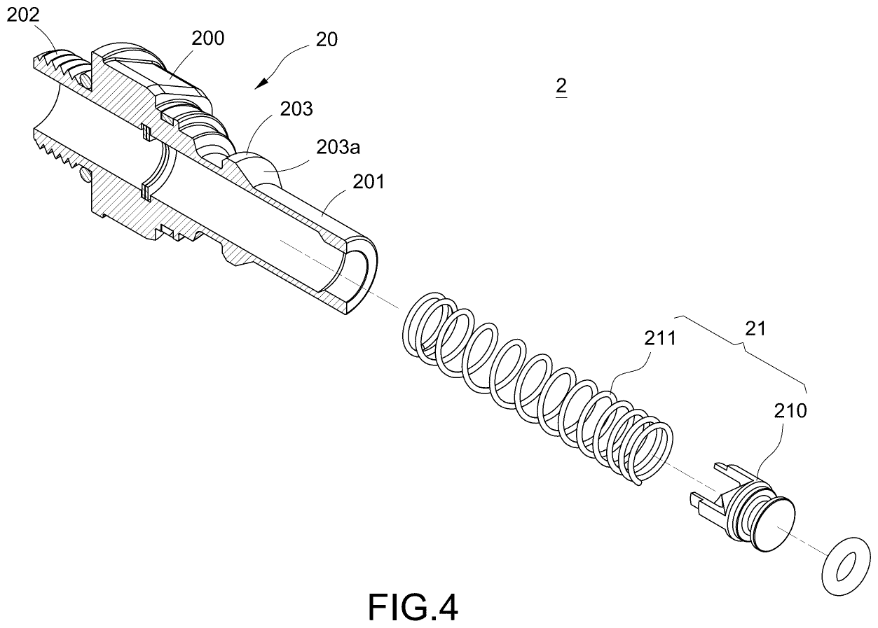

As shown in FIG. 4, the mating connector 2 mentioned above is used to insert into the socket 101 of the liquid-cooling plug connector 1, thereby pushing the piston 120 in the plugged body 10 away from the backstop member 121, thereby connecting the socket 101 with the hollow area 100 for the liquid to circulate. The mating connector 2 includes a mating body 20 and a closure kit 21 arranged in the mating body 20. Moreover, the mating body 20 may include a base part 200 and a mating part 201 which is extended along the axial direction from the base part 200. A pipe-connecting opening 202 protrudes backward from the base part 200 and is provided for the mating connector 2, so that the mating connector 2 may also be arranged on the pipeline of the cooling system (not shown) for the liquid circulation and plug into the liquid-cooling plug connector 1 to communicate with the liquid loop. The closure kit 21 is arranged in the mating part 201, and includes a pushing member 210 and an elastic component 211 for pushing the pushing member 210 forward to close the mating part 201. When the mating connector 2 does not plug into the liquid-cooling plug connector 1 mentioned above, the closure kit 21 may also prevent the liquid in the connected pipeline (not shown) from flowing out.

Therefore, through the structure and the constitution mentioned above, the liquid-cooling plug connector 1 and the connecting apparatus 3 having the same of the present disclosure may be obtained.

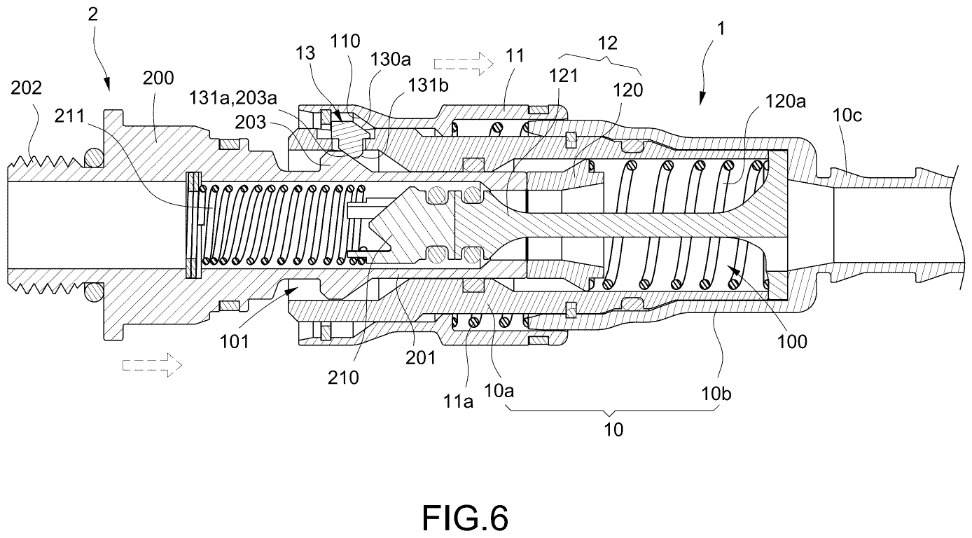

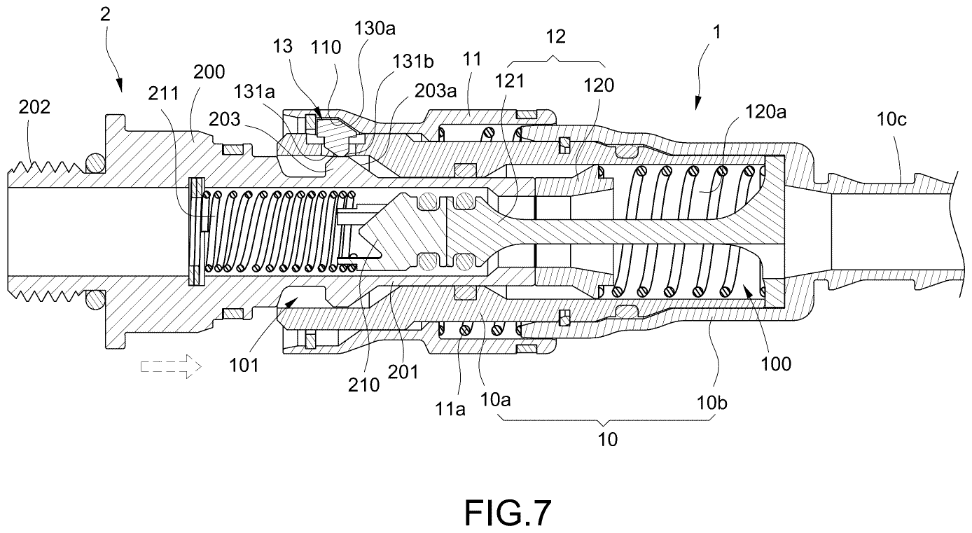

Therefore, as shown in FIG. 5, when the mating connector 2 plugs into the liquid-cooling plug connector 1 mentioned above, the mating part 201 of the mating connector 2 inserts into the socket 101 of the liquid-cooling plug connector 1, so that the backstop assembly 12 in the liquid-cooling plug connector 1 may be triggered to act by the action of plugging into each other, to communicate with the mating connector 2 and allow the liquid to pass through. In the embodiment of the present disclosure, the mating part 201 of the mating connector 2 pushes the piston 120 of the liquid-cooling plug connector 1 to move backward. As shown in FIG. 6, when the piston 120 moves backward and disengages from the backstop member 121, the backstop member 121 may also extend into the mating part 201 of the mating connector 2 to push the pushing member 210 of the closure kit 21 backward, thereby allowing the liquid to circulate in the liquid-cooling plug connector 1 and the mating connector 2, as shown in FIG. 7.

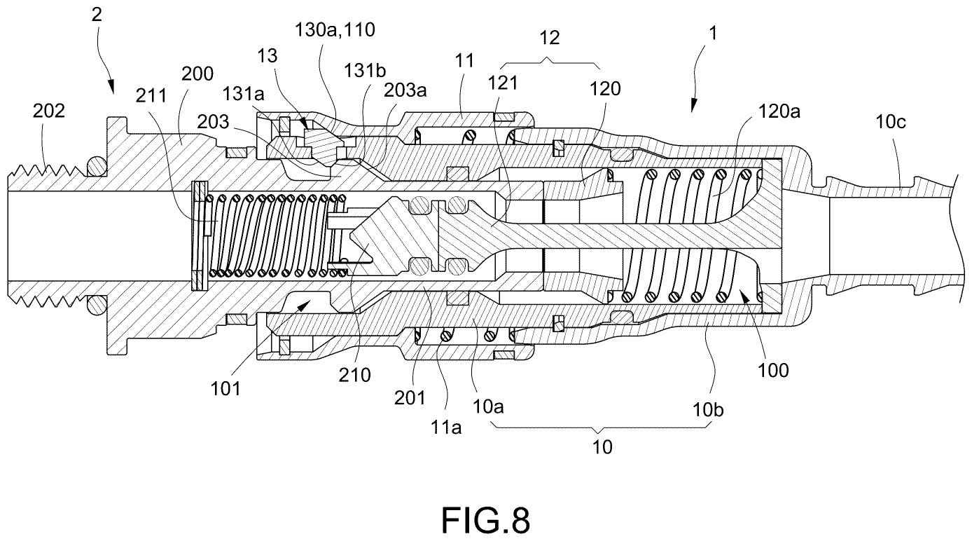

Please refer to FIG. 6 to FIG. 8 again. To enable the liquid-cooling plug connector 1 and the mating connector 2 to be locked and maintained the plugging state after the liquid-cooling plug connector 1 and the mating connector 2 are docked, a pushing part 203 is provided on an outer ring of the mating part 201 of the mating connector 2. The pushing part 203 has a pushing surface 203a (which is inclined) in the direction toward the mating. As shown in FIG. 6, when internal parts of the liquid-cooling plug connector 1 and the mating connector 2 are about to be connected to each other, the pushing part 203 happens to push the locking component 13 of the liquid-cooling plug connector 1. The fixing part 131 of the locking component 13 has an operating surface 131a extending into the socket 101 through the operating hole 102, and a fixing surface 131b opposite to the operating surface 131a. The operating surface 131a faces the outside of the socket 101. The fixing surface 131b faces the inside of the socket 101. The pushing surface 203a of the pushing part 203 of the mating connector 2 pushes against the operating surface 131a, so that the operating surface 131a of the locking component 13 slides upward on the pushing surface 203a, thereby the locking component 13 crossing the pushing part 203 so that the mating part 201 inserts into the plugged body 10, so that the fixing surface 131b of the locking component 13 abuts against the back side of the pushing part 203; at the same time, the unlocking assembly 11 is used to have the elastic force to move toward the front end of the plugged body 10, so as to push the locking component 13 forward and prevent the locking component 13 from retreating and unlocking. Furthermore, the locking component 13 is provided with an abutment surface 130a on the limiting part 130. The unlocking assembly 11 is provided with a stopping surface 110 (which is annular; namely, the stopping surface 110 is an annular surface) in the unlocking assembly 11 which cooperates with and abuts against the abutment surface 130a, to prevent the locking component 13 from withdrawing in the reverse direction and unlocking.

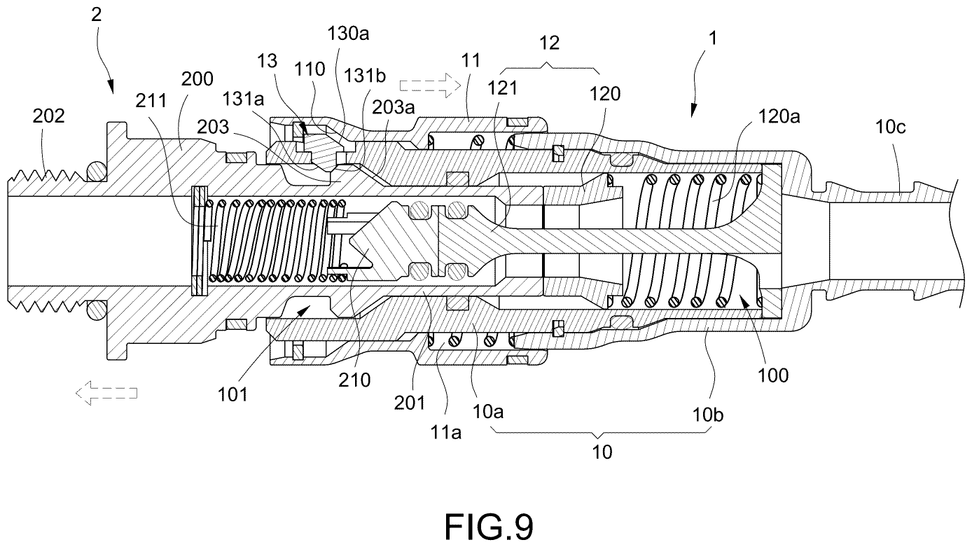

On the contrary, as shown in FIG. 9, when the liquid-cooling plug connector 1 and the mating connector 2 mentioned above are required to be detached, only the unlocking assembly 11 needs to be pushed backward so that the stopping surface 110 of the unlocking assembly 11 is away from the abutment surface 130a of the locking element 13, and then the mating connector 2 may be quickly unplugged from the liquid-cooling plug connector 1 to achieve the object of the quick plugging and unplugging.

To sum up, the present disclosure may indeed achieve the object of the use described in the above description to solve the deficiencies of the prior arts. Because the present disclosure is novel and nonobvious, which fully meets the requirements for the invention patent application, the application is filed in accordance with the patent law and required to be examined for details to grant a patent for the present disclosure to protect the rights of the inventor.

However, the above descriptions are only the better and possible embodiments of the present disclosure and do not limit the patent scope of the present disclosure. Therefore, any equivalent technologies, means, and other changes made by using the contents of the descriptions and drawings of the present disclosure are equally applicable and included in the scope of the present disclosure, which is stated here.

What is claimed is:

1. A liquid-cooling plug connector comprising:
a plugged body having a hollow area in the plugged body, the hollow area extending toward a front end of the plugged body to form a socket, the plugged body having at least one operating hole relative to a periphery of the socket;
an unlocking assembly elastically adapted to sheathe outside the plugged body;
a backstop assembly arranged in the hollow area and elastically blocked between the socket and the hollow area; and
at least one locking component movably arranged in the operating hole and having a limiting part located outside the operating hole, a fixing part extended from the limiting part downward to move along an axial direction in the operating hole, an operating surface on the fixing part and extending into the socket through the operating hole, and a fixing surface opposite to the operating surface,
wherein the unlocking assembly has a stopping surface in the unlocking assembly, the stopping surface is elastically abutted against the limiting part to cause the locking component to move outward along the axial direction in the operating hole.

2. The liquid-cooling plug connector of claim 1, wherein the plugged body includes a body part and a pipe-connecting part; the hollow area is in the body part; the pipe-connecting par is sleeved on the body part and closes the hollow area.

3. The liquid-cooling plug connector of claim 1, wherein the backstop assembly includes a piston and a backstop member blocked and arranged on the piston; the piston is pushed by an elastic force and is blocked together with the backstop member between the socket and the hollow area.

4. The liquid-cooling plug connector of claim 1, wherein the locking component is in plural numbers and the operating hole is in corresponding plural numbers.

5. The liquid-cooling plug connector of claim 1, wherein a size of the fixing part along a radial direction of the operating hole is smaller than a size of the limiting part along the radial direction of the operating hole.

6. The liquid-cooling plug connector of claim 1, wherein an abutment surface is arranged on the limiting part and cooperates with and abuts against the stopping surface.

7. The liquid-cooling plug connector of claim 1, wherein the stopping surface is an annular surface.

8. A connecting apparatus comprising:
a mating connector; and
a liquid-cooling plug connector plugged by the mating connector and comprising:
a plugged body having a hollow area in the plugged body, the hollow area extending toward a front end of the plugged body to form a socket, the plugged body having at least one operating hole relative to a periphery of the socket;
an unlocking assembly elastically adapted to sheathe outside the plugged body;
a backstop assembly arranged in the hollow area and elastically blocked between the socket and the hollow area; and
at least one locking component movably arranged in the operating hole and having a limiting part located outside the operating hole, a fixing part extended from the limiting part downward to move along an axial direction in the operating hole, an operating surface on the fixing part and extending into the socket through the operating hole, and a fixing surface opposite to the operating surface,
wherein when the mating connector inserts into the socket of the plugged body, the operating surface is pushed to cause the locking component to slide and the fixing surface latches the mating connector; the unlocking assembly has a stopping surface in the unlocking assembly; the stopping surface is elastically abutted against the limiting part to cause the locking component to move outward along the axial direction in the operating hole.

9. The connecting apparatus of claim 8, wherein the mating connector comprises a mating body and a closure kit arranged in the mating body.

10. The connecting apparatus of claim 9, wherein the mating body comprises a base part and a mating part extended along the axial direction from the base part; the closure kit is arranged in the mating part.

11. The connecting apparatus of claim 10, wherein a pushing part is provided on an outer ring of the mating part; the pushing part has a pushing surface which is inclined and used to push against the operating surface.

12. The connecting apparatus of claim 8, wherein the plugged body includes a body part and a pipe-connecting part; the hollow area is in the body part; the pipe-connecting par is sleeved on the body part and closes the hollow area.

13. The connecting apparatus of claim 8, wherein the backstop assembly includes a piston and a backstop member blocked and arranged on the piston; the piston is pushed by an elastic force and is blocked together with the backstop member between the socket and the hollow area.

14. The connecting apparatus of claim 8, wherein the locking component is in plural numbers and the operating hole is in corresponding plural numbers.

15. The connecting apparatus of claim 8, wherein a size of the fixing part along a radial direction of the operating hole is smaller than a size of the limiting part along the radial direction of the operating hole.

16. The connecting apparatus of claim 8, wherein an abutment surface is arranged on the limiting part and cooperates with and abuts against the stopping surface.

17. The connecting apparatus of claim 8, wherein the stopping surface is an annular surface.
